(19) United States
(12) Patent Application Publication
(10) Pub. No.: US 2023/0194885 A1
(43) Pub. Date: Jun. 22, 2023

(54) BEAM TRANSFORMER

(71) Applicant: TRUMPF Laser- und Systemtechnik GmbH, Ditzingen (DE)

(72) Inventors: Thomas Zeller, Sindelfingen (DE); Andreas Heimes, Renningen (DE); Torsten Beck, Stuttgart (DE); Mario Schwartz, Stuttgart (DE); Hans Georg Schuller, Ludwigsburg (DE)

(21) Appl. No.: 18/173,805

(22) Filed: Feb. 24, 2023

Related U.S. Application Data
(63) Continuation of application No. PCT/EP2021/072210, filed on Aug. 10, 2021.

(30) Foreign Application Priority Data
Aug. 27, 2020 (DE) 10 2020 122 484.2

(51) Int. Cl. G02B 27/09; G02B 7/18

(52) U.S. Cl. CPC G02B 27/0994; G02B 7/1815

(57) ABSTRACT

A beam transformer for transforming an input laser beam into a transformed laser beam for use in laser systems for line illumination of an object includes a transparent planar optical element that has a front surface and a back surface, which extend substantially parallel to one another. The optical element has an entrance area and an exit area, and a plurality of reflective surfaces for beam deflection. The beam transformer further includes a cooling device provided at least on the front surface or the back surface of the optical element.

### CROSS REFERENCE TO RELATED APPLICATIONS

This application is a continuation of International Application No. PCT/EP2021/072210 (WO 2022/043044 A1), filed on Aug. 10, 2021, and claims benefit to German Patent Application No. DE 10 2020 122 484.2, filed on Aug. 27, 2020. The aforementioned applications are hereby incorporated by reference herein.

### FIELD

Embodiments of the present invention relate to a beam transformer for transforming an input laser beam into a transformed beam with reduced temporal and/or spatial coherence, in particular for use in laser systems for line illumination of an object.

### BACKGROUND

WO 2018/019374 A1 describes a beam transformer. Described herein is a laser system for providing a laser line on a work surface for line illumination of an object.

Exemplary applications of such laser systems include the recrystallization of silicon oxide layers deposited on glass substrates, for instance in TFT displays, laser-assisted doping of solar cells, for example, and the laser lift-off methods when producing micro-electronic devices.

In such a system, the laser line extends over a significant length in a first direction and only over a small path in a second direction. The laser system comprises a laser source for providing a laser beam as a basis for an elongate input laser beam, which extends along a direction of extent, and a homogenization and focusing unit for homogenizing the elongate laser beam in order to form a laser line. Described herein is a beam transformer for shaping the input laser beam into a transformed beam for the line illumination of an object. The beam transformer comprises a transparent, monolithic, planar, optical element having a front surface and a back surface which extend substantially parallel to one another. An entrance area for the entrance of the laser beam is provided on the front surface. An exit area for the exit of the transformed beam is provided on the back surface. The optical element comprises a plurality of reflective surfaces for beam deflection.

Although such a beam transformer is suitable by all means for carrying out the desired transformation, it was found in practice that the imaging performance is improvable. The line width and the desired (generally trapezoidal) beam profile are not maintained precisely enough under all conditions.

### SUMMARY

Embodiments of the present invention provide a beam transformer for transforming an input laser beam into a transformed laser beam for use in laser systems for line illumination of an object. The beam transformer includes a transparent planar optical element that has a front surface and a back surface, which extend substantially parallel to one another. The optical element has an entrance area and an exit area, and a plurality of reflective surfaces for beam deflection. The beam transformer further includes a cooling device provided at least on the front surface or the back surface of the optical element.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a perspective representation of a beam transformer according to embodiments of the present invention;

FIG. 2 shows a simplified side view of the optical element according to FIG. 1, as seen from the front side;

FIG. 3 shows a view of the optical element, as seen from the back side;

FIG. 4 shows a simplified cross section through the optical element with heat sinks on the front side and back side, and a fastening element arranged thereover, with the representation of the cooling channels within the sinks having been dispensed with for simplification reasons;

FIG. 4a shows an alternative embodiment of the beam transformer according to FIG. 4, with only the optical element in cross section being depicted together with cooling elements in the form of heat pipes or Peltier elements;

FIG. 4b shows a further modification of the beam transformer, with the optical element being depicted in conjunction with a cooling device in the form of a cooling air line which is fed by way of a fan, according to some embodiments;

FIG. 4c shows a further modification of a beam transformer, with only a heat sink being depicted, the latter being provided with cooling ribs protruding to the outside in angled fashion for the purposes of providing passive cooling, according to some embodiments;

FIG. 5a shows a representation of the change in the measured length of the short axis of the elongate laser beam over time, in micrometers plotted against time in minutes, without cooling, according to some embodiments;

FIG. 5b shows a representation according to FIG. 5a but with a cooling on both the front surface and the back surface, with active cooling by means of a cooling agent passing through the heat sinks, according to some embodiments.

### DETAILED DESCRIPTION

Embodiments of the present invention provide a beam transformer that includes a cooling device provided at least on the front surface or the back surface.

During operation, laser radiation is absorbed at each interface and in the glass body of the optical element itself. This leads to non-uniform heating of the optical element. Since the heat conduction within the glass is poor, there is only a very limited temperature equalization as a result of heat conduction in the glass body. This leads to a non-uniform imaging behavior. The line width and the desired beam profile, in particular, are not maintained precisely enough under all conditions.

As a result of the use according to embodiments of the invention of a cooling device at least on the front surface or the back surface, preferably on both the front surface and the back surface, it is possible to largely homogenize the temperature distribution within the optical element. This significantly improves the imaging behavior.

According to a further embodiment of the invention, the cooling device comprises a heat sink at least on the front surface or the back surface of the optical element.

According to a further embodiment of the invention, the heat sink comprises a thermally well conductive material with a thermal conductivity of at least 50 Wm⁻¹K⁻¹, preferably copper or aluminum.

This enables good heat dissipation or a uniform temperature distribution.

According to a further embodiment of the invention, an intermediate layer which is made of a thermally conductive material and is softer than the material of which the heat sink is made is arranged between the front surface and/or the back surface of the optical element and the surface of the heat sink.

According to a further embodiment of the invention, the intermediate layer comprises indium.

This is advantageous in that this avoids damage to the reflective surfaces of the optical element as a result of differences in the coefficients of thermal expansion of the heat sink and the glass body of which the optical element is made.

Indium has a good thermal conductivity and although this is lower than that of copper indium has a very low flow stress and is very soft even at room temperature or slightly elevated temperatures on account of the low melting point. Therefore, an intermediate layer comprising indium firstly protects a reflective layer of the optical element therebelow and secondly enables a good heat transfer to the adjacent heat sink. Overall, the soft intermediate layer, which preferably comprises indium, prevents damage to the reflective coating of the glass body and simultaneously improves the thermal contact to the heat sink.

According to a further embodiment of the invention, the intermediate layer has a thickness of 0.02 to 1 mm, preferably a thickness of approximately 0.1 mm.

Such a thickness yields a good compromise between optimal heat transfer between the optical element and the adjacent heat sink and low thermal losses on account of the poorer thermal conductivity of indium vis-à-vis copper, while simultaneously providing sufficient protection of a mirroring of the optical element.

According to a further embodiment of the invention, the heat sink comprises connectors for supplying and removing cooling agent.

This ensures particularly effective cooling.

According to an alternative embodiment, the heat sink comprises cooling ribs for passive cooling. By way of example, these may protrude to the outside in angled fashion, for instance as typically known from component cooling in the case of electronic circuits. However, even if no additional cooling ribs or active cooling by cooling agent are/is provided, the layer on the front surface and/or back surface and made of a thermally well conductive material acts as a heat sink, which brings about heat dissipation to the surroundings.

According to an alternative embodiment of the invention, the cooling device comprises means for generating a cooling airflow, heat pipes, or Peltier elements. Effective cooling of the surfaces of the optical object can also be ensured using such cooling devices. Equally, cooling by means of a heat sink in conjunction with an additional passage of cooling agent represents a preferred embodiment, which is particularly economical and effective.

surface,

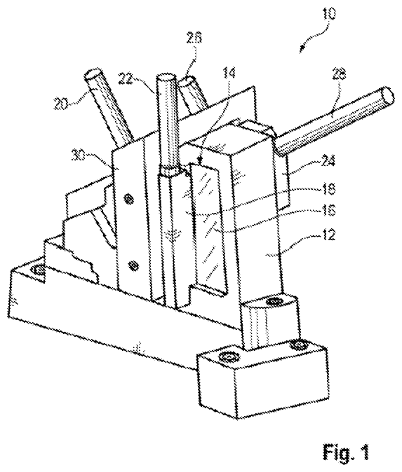

FIG. 1 depicts a perspective view of a beam transformer according to embodiments of the present invention, which is denoted by 10 overall.

The beam transformer 10 is part of a laser system designed to provide a line-shaped laser beam at a work surface for illuminating an object, as described in detail in WO 2018/019374 A1, which is incorporated herein in full by reference.

Then, the laser line extends over a significant length in a first direction and has only a small extent in a second direction. The laser system comprises a laser source for emitting a laser beam as a basis for an elongate input laser beam along a direction of propagation, and a homogenization and focusing unit for homogenizing and focusing the elongate laser beam in order to form the laser line. In the process, a plurality of laser systems may be arranged next to one another in order together to form an extensive laser line comprising a sequence of laser lines. A beam transformer for transforming an input laser beam into a transformed beam with reduced spatial and/or temporal coherence is a part of the optical system in such a laser system.

According to WO 2018/019374 A1, this is a transparent, planar, optical element having a front surface and a back surface which extend substantially parallel to one another, having an entrance area on the front surface and an exit area on the back surface, and having a plurality of reflective surfaces for beam deflection. Structure and functionality of such a beam transformer are known. For details, reference is made to WO 2018/919374 A1 in this context.

The transformation within the beam transformer generally reduces the beam quality in the X-direction (direction of extent of the longitudinal beam) and simultaneously improves the beam quality in the Y-direction (“width”) of the laser beam, while the Z-direction is the direction of propagation of the laser beam.

According to FIG. 1, the beam transformer 10 according to embodiments of the present invention comprises a housing 12 which accommodates a transparent, planar, monolithic optical element denoted by 14 overall. The planar, optical element 14 has a front surface and a back surface which extend parallel to one another, with an entrance area 16 on the front surface and an exit area on the back surface (not visible in FIG. 1).

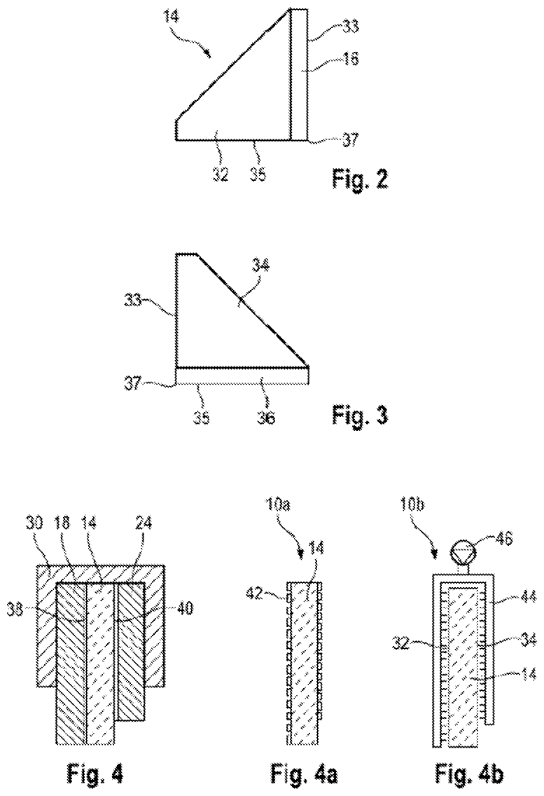

According to FIGS. 2 and 3, the optical element 14 has a substantially triangular shape, with two orthogonal longitudinal sides 33, 35 that emanate from a common edge 37. A substantially rectangular entrance area 16 is formed on the front surface 32 (FIG. 2), while a substantially rectangular exit area 36 which runs perpendicular to the entrance area 16 is formed on the back side 34 (FIG. 3). The entrance area 16 and the exit area 36 intersect in an edge region adjoining the common edge 37. The entrance area 16 and the exit area 36 are provided with anti-reflection coatings.

By contrast, the front surface 32 and the back surface 34 are coated with highly reflective coatings on the outside. As a result, before an obliquely incident laser beam that has been widened in ellipsoid fashion by the upstream, anamorphic, optical arrangement exits through the exit area 36 again, the said beam is reflected multiple times within the optical element 14. However, laser beams incident perpendicularly in the overlap region between entrance area 16 and exit area 36 directly leave through the exit area 36 without being reflected.

According to embodiments of the present invention, a respective heat sink 18 or 24 (FIG. 1) is now provided both on the front surface 32 and on the back surface 34, the heat sink in each case extending over the entire front surface 32 or over the entire back surface 34, with only the entrance area 16 and the exit area 36 being excluded. The heat sinks 18, 24 comprise copper and a cooling agent flows through each of these. In FIG. 1, the associated cooling agent lines 20, 22 of the heat sink 18 on the front side and the cooling agent lines 26, 28 of the heat sink 24 on the back surface are identifiable.

Laser radiation is absorbed at each interface and in the glass body of the optical element 14 itself, and leads to non-uniform heating of the optical element 14. Since the heat conduction within the glass is very poor, there is only a limited temperature equalization as a result of heat conduction in the optical element 14. According to embodiments of the present invention, temperature equalization is now provided as a result of the heat sinks 18, 24, as a result of which the energy is partially dissipated and otherwise distributed uniformly over the entire optical element 14.

Since glass has a very low coefficient of thermal expansion but the heat sinks that preferably comprise copper have a significantly higher coefficient of thermal expansion, there is relative motion between the optical element 14 and the heat sinks 18, 24 in the case of temperature changes. Since each interface is provided with a highly reflective layer, these could be damaged as a result of relative motion. To prevent this, a respective intermediate layer 38, 40 is provided between the heat sink 18 on the front surface 32 and between the heat sink 24 on the back surface 34 (FIG. 4), the intermediate layer comprising a thin indium film with a thickness of approximately 0.1 mm. Indium has a melting point of 157° C. At approximately 81.6 Wm⁻¹K⁻¹, the thermal conductivity of indium is lower than that of copper (398 W⁻¹K⁻¹), but indium allows good adaptation to the contact faces on both sides as a result of its very low flow stress, which is approximately 1 MPa at room temperature. Indium is very soft, and so the indium film adapts to surface unevenness and provides good compensation in the case of temperature variations. The contact face between the heat sinks 18, 24 and the optical element 14 is maximized in this way, with simultaneously the sensitive reflective coatings at the front surface 32 and the back surface 34 being protected against damage (it should be observed that the thickness of the intermediate layers 38, 40 made of indium has been depicted excessively large vis-à-vis the thickness of the heat sinks 18, 24 in FIG. 4 for reasons of clarity; moreover, the cooling agent channels in the heat sinks 18, 24, to which the cooling agent lines 20, 22 and 26, 28 are connected, have not been depicted in this figure for simplification purposes).

An enclosing fastening element 30 in the form of a U-shaped flange, which is screwed to the heat sinks 18, 24 on the side in each case, serves to fasten the two heat sinks 18, 24.

It is understood that a plurality of beam transformers 10 may be arranged next to one another when use is made of a plurality of laser systems arranged next to one another for the purposes of obtaining a lengthened line beam, as is known from WO 2018/019374 A1.

Alternatively, the cooling device may also have other cooling agents instead of heat sinks 18, 24. To this end, a plurality of heat pipes or Peltier elements may be provided on the front surface 32 and on the back surface 34, as depicted in FIG. 4a in exemplary fashion. In this case, the beam transformer is denoted by 10a overall.

In a further variant in accordance with FIG. 4b, the beam transformer is denoted by 10b overall. For cooling the optical element 14, a respective cooling air line 44 is provided at a certain distance from the front surface 32 and from the back surface 34, the cooling air line being supplied with cooling air by way of a fan 46. From the cooling air lines 44, cooling air emerges in the direction of the optical element 14 via associated nozzles, in order to cool the front surface 32 and the back surface 34.

FIG. 4c shows a further variant of a beam transformer, denoted by 10c overall. In this case, the heat sink 18 is only depicted on the front side. It is designed as a passive heat sink, on which a plurality of cooling ribs 48 protruding to the outside in angled fashion are provided.

Overall, the use of active heat sinks according to FIG. 4, to which cooling agent lines are connected, or optionally the use of passive heat sinks according to FIG. 4c is preferred, since this leads to particularly intense and uniform cooling and the structure is simpler and more cost-effective than in the case where heat pipes or Peltier elements are used.

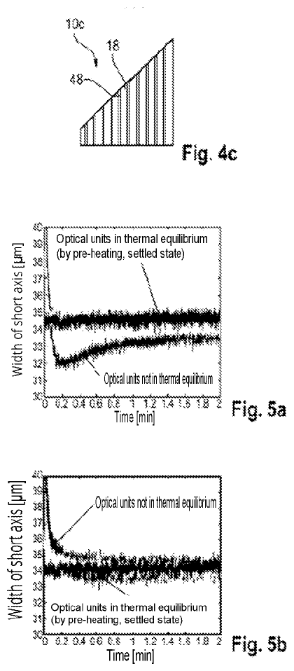

The effect of active cooling of the beam transformer 10 both on the front surface and on the back surface is shown in FIGS. 5a,b in comparison. FIG. 5a shows the measured width of the short axis of the elongate laser beam in the processing plane (FWHM=beam width at half the height of the profile) without cooling, while FIG. 5b shows the measured width of the short axis of the elongate laser beam in the processing plane (FWHM=beam width at half the height of the profile) with cooling. It is evident here that the width of the line changes significantly over a period of time of 1-2 min in the uncooled version. The power density also varies when the width of the line changes since the radiation is distributed over a smaller or larger area. This is undesirable.

The non-uniform heating leads to a (local) deformation of the mirror surfaces on both sides, and possibly also to a change in the refractive index. As a result, the emerging beam changes in shape and height. Since this geometry is imaged onto the processing plane, this also results in a change in the geometry of the line in the processing plane, predominantly in the line width and also in the trapezoidal beam profile.

The significant improvement in the cooled embodiment according to FIG. 5b is clearly evident.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A beam transformer for transforming an input laser beam into a transformed laser beam for use in laser systems for line illumination of an object, the beam transformer comprising:
a transparent planar optical element having a front surface and a back surface that extend substantially parallel to one another, the optical element having an entrance area and an exit area, the optical element having a plurality of reflective surfaces for beam deflection, and
a cooling device provided at least on the front surface or the back surface of the optical element.

2. The beam transformer as claimed in claim 1, wherein the cooling device comprises a heat sink at least on the front surface or the back surface.

3. The beam transformer as claimed in claim 2, wherein the heat sink comprises a thermally conductive material with a thermal conductivity of at least 50 Wm⁻¹K⁻¹.

4. The beam transformer as claimed in claim 2, wherein the heat sink comprises copper or aluminum.

5. The beam transformer as claimed in claim 2, further comprising:
an intermediate layer arranged between the front surface of the optical element and the surface of the heat sink, and/or between the back surface of the optical element and the surface of the heat sink.

6. The beam transformer as claimed in claim 5, wherein the intermediate layer comprises a thermally conductive material that is softer than a material of the heat sink.

7. The beam transformer as claimed in claim 5, wherein the intermediate layer comprises indium.

8. The beam transformer as claimed in claim 5, wherein the intermediate layer has a thickness that ranges from 0.02 to 1 mm.

9. The beam transformer as claimed in claim 8, wherein the intermediate layer has a thickness of approximately 0.1 mm.

10. The beam transformer as claimed in claim 2, wherein the heat sink comprises cooling ribs for passive cooling.

11. The beam transformer as claimed in claim 2, wherein the heat sink comprises connectors for supplying and removing a cooling agent.

12. The beam transformer as claimed in claim 1, wherein the cooling device is provided on both the front surface and the back surface of the optical element.

13. The beam transformer as claimed in claim 1, wherein the cooling device comprises means for generating a cooling airflow.

14. The beam transformer as claimed in claim 1, wherein the cooling device comprises heat pipes.

15. The beam transformer as claimed in claim 1, wherein the cooling device comprises Peltier elements.
